(19) United States
(12) Patent Application Publication
(10) Pub. No.: US 2026/0339261 A1
(43) Pub. Date: Oct. 29, 2026

(54) BLADE FOR ELECTROPHOTOGRAPHY AND IMAGE FORMING APPARATUS

(71) Applicants: Masahiro OHMORI, Kanagawa (JP); Keiichiro JURI, Tokyo (JP)

(72) Inventors: Masahiro OHMORI, Kanagawa (JP); Keiichiro JURI, Tokyo (JP)

(21) Appl. No.: 19/485,686

(22) PCT Filed: Jul. 8, 2024
(86) PCT No.: PCT/IB2024/056609

§ 371 Date: Nov. 19, 2025

(30) Foreign Application Priority Data
Jul. 24, 2023 (JP) 2023-119650

(51) Int. Cl. G03G 21/00

(52) U.S. Cl. CPC G03G 21/0017

(57) ABSTRACT

A blade for electrophotography includes an elastic body including a contact portion contacting a surface of an image bearer. The contact portion is made of a polyurethane elastomer containing a reaction product of polytetramethylene ether glycol, aromatic isocyanate, and amine and has a Martens hardness of 5.0 N/mm² or more and 30.0 N/mm² or less.

### TECHNICAL FIELD

Embodiments of the present disclosure relate to a blade for electrophotography and an image forming apparatus.

### BACKGROUND ART

An electrophotographic image forming apparatus typically includes a cleaner that removes transfer residual toner remaining on the surface of an image bearer after a transfer process and cleans the surface of the image bearer in order to use the surface of the image bearer repeatedly for image formation. The cleaner generally includes a cleaning blade made of elastic material such as polyurethane rubber because of its simple structure and excellent toner removing performance. In addition, an image forming apparatus known in the art includes a lubricant supply device that supplies lubricant such as fatty acid metal salt to the surface of the image bearer to reduce the friction coefficient between the cleaning blade and the surface of the image bearer.

### CITATION LIST

### Patent Literature

### [PTL 1]

Japanese Unexamined Patent Application Publication No. 2000-330443

### [PTL 2]

Japanese Patent No. 5505784

### [PTL 3]

Japanese Patent No. 5860393

### SUMMARY OF INVENTION

### Technical Problem

In the above-described image forming apparatus, supplying a too small amount of the lubricant to the surface of the image bearer cannot sufficiently reduce the friction coefficient, and thus, cannot sufficiently prevent a problem due to a high friction coefficient (for example, curling of the cleaning blade or a reduction in the life of the image bearer). In contrast, supplying a too large amount of the lubricant to the surface of the image bearer increases the amount of the lubricant adhering to various parts and devices around the image bearer, and thus causes a problem due to the adhesion of the lubricant (for example, the occurrence of an abnormal image due to the adhesion of the lubricant to the charging member, or the developer bearer). For this reason, the amount of the lubricant supplied to the surface of the image bearer is controlled to be an appropriate amount in the image forming apparatus having a configuration to supply the lubricant to the surface of the image bearer.

In one type of image forming apparatus described above, the lubricant is supplied to the surface of the image bearer at a position upstream from a blade contact portion at which the cleaning blade contacts the image bearer in a surface movement direction in which the surface of the image bearer moves. In this configuration, the cleaning blade spreads and levels the lubricant supplied to the surface of the image bearer. This configuration does not include a lubricant leveling member in addition to the cleaning blade to level the lubricant but can level the lubricant supplied to the surface of the image bearer to some extent. However, this configuration cannot sufficiently level the lubricant because the lubricant enters the contact portion of the cleaning blade together with the transfer residual toner, which causes a difference in the amount of the lubricant between the region in which the transfer residual toner exists and the region in which the transfer residual toner does not exist. As a result, this configuration generates a portion to which a too large amount of lubricant is applied and a portion to which a too small amount of lubricant is applied on the surface of the image bearer and may cause the above-described problem locally. In addition, the lubricant adheres to the transfer residual toner and is cleaned together with the toner in the above-described configuration. In this case, controlling the amount of the lubricant supplied to the image bearer and consumed by the image bearer is difficult because accurately estimating the amount of the lubricant removed from the image bearer is difficult. As a result, the above-described problem is likely to occur.

Another type of image forming apparatus is disclosed that includes a lubricant supplier disposed downstream from the contact portion of the cleaning blade in the surface movement direction and a lubricant leveling blade disposed downstream from the lubricant supplier to level the lubricant. In the above-described image forming apparatus, the lubricant leveling blade can sufficiently level the lubricant supplied to the surface of the image bearer because the cleaner cleans the surface of the image bearer before the lubricant is supplied to the surface of the image bearer. In addition, the above-described structure can prevent the lubricant from adhering to the transfer residual toner and being cleaned together with the toner and easily control the supply amount and the consumption amount of the lubricant. Japanese Unexamined Patent Application Publication No. 2000-330443 discloses the lubricant leveling blade that has an edge line portion contacting the surface of the image bearer so that the edge line of the lubricant leveling blade intersects the surface movement direction to level the lubricant supplied to the surface of the image bearer. The lubricant leveling blade disclosed in the above is a right-angle blade having a blade corner angle of 90° that is formed by two surfaces of the lubricant leveling blade that are one surface facing the surface of the image bearer upstream from the edge line portion at which the lubricant leveling blade contacts the surface of the image bearer and the other surface of the image bearer downstream from the edge line portion.

Currently, the image forming apparatus working for a long time without maintenance is required. Therefore, it is desired to maintain the function of the lubricant leveling blade constant for a long time. A countermeasure to maintain the function of the lubricant leveling blade is reducing the amount of wear over time in the edge line portion of the lubricant leveling blade that abuts against the surface of the image bearer. Japanese Patent No. 5505784 discloses another lubricant leveling blade that is an obtuse angle blade having an obtuse angle as the blade corner angle that is formed by the two surfaces of the lubricant leveling blade that are the one surface facing the surface of the image bearer upstream from the edge line portion at which the lubricant leveling blade contacts the surface of the image bearer and the other surface of the image bearer downstream from the edge line portion.

An image forming apparatus not including the lubricant supply device and the lubricant leveling blade typically uses the cleaning blade made of polyurethane rubber having a high hardness so that the friction with the image bearer is as small as possible. Japanese Patent No. 5860393 discloses a blade for the electrophotography including an edge portion and a backup portion that are made of polyurethane having different hardness.

An object of the present disclosure is providing a blade for the electrophotography that can maintain a lubricant applying function and a cleaning function to clean the image bearer for a long time.

### Solution to Problem

In order to achieve the above object, the present disclosure discloses a blade for the electrophotography. The blade includes an elastic body having a contact portion contacting a surface of an image bearer. The contact portion is made of polyurethane elastomer containing a reaction product of polytetramethylene ether glycol, aromatic isocyanate, and amine. The contact portion has a Martens hardness of 5.0 N/mm² or more and 30.0 N/mm² or less.

### Advantageous Effects of Invention

According to one aspect of the present disclosure, the blade for the electrophotography that can maintain the lubricant applying function and the cleaning function to clean the image bearer for a long time is provided.

### BRIEF DESCRIPTION OF DRAWINGS

A more complete appreciation of embodiments of the present disclosure and many of the attendant advantages and features thereof can be readily obtained and understood from the following detailed description with reference to the accompanying drawings.

FIG. 1 is a schematic view of a blade for the electrophotography.

FIG. 2 is a schematic view of a blade for the electrophotography contacting an image bearer.

FIG. 3 is a schematic diagram illustrating a configuration of an image forming apparatus.

FIG. 4 is a schematic diagram illustrating a configuration of one of image forming units in the image forming apparatus of FIG. 3.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DESCRIPTION OF EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result. Referring now to the drawings, embodiments of the present disclosure are described below. As used herein, the singular forms “a,” “an,” and “the” are intended to include the plural forms as well, unless the context clearly indicates otherwise.

A blade for the electrophotography according to one aspect of the present disclosure includes an elastic body having a contact portion in contact with the surface of an image bearer. The contact portion is made of the polyurethane elastomer containing the reaction product of polytetramethylene ether glycol, aromatic isocyanate, and amine. The contact portion has a Martens hardness of 5.0 N/mm² or more and 30.0 N/mm² or less. The Martens hardness may be referred to as HM below.

A lubricant leveling blade known in the art that has an obtuse blade corner angle has certainly reached a certain level in the function of preventing the contact portion from being turned up or deformed and applying the lubricant to the surface of the image bearer. However, the lubricant leveling blade known in the art is insufficient to achieve an increase in speed and image quality in recent image forming apparatuses. A cleaning blade for the electrophotographic system not including the lubricant is made of polyurethane rubber in the related art. The cleaning blade made of polyurethane rubber increases the frictional force between the image bearer and the cleaning blade. The increased frictional force pulls the cleaning blade in the direction of movement of the image bearer and causes a problem that the contact portion of the cleaning blade (a leading edge line portion of the cleaning blade) is turned up. If a cleaning operation is continued while the contact portion of the cleaning blade is turned up, local wear occurs at a position several micrometers away from the contact portion of a leading end surface of the cleaning blade. If the cleaning operation is further continued in such a state, the local wear becomes large, and eventually, the contact portion is worn out and becomes missing. Missing the contact portion increases the frictional force and causes cleaning failure and, in particular, a problem that an external additive such as silica in the toner adheres to the image bearer.

The present inventors have made diligent studies to solve the above-described problems. As a result, the inventors found that setting the Martens hardness of the contact portion contacting the surface of the image bearer in the elastic body of the blade to be high, i.e., 5.0 N/mm² or more and 30.0 N/mm² or less stabilizes the behavior of the leading edge line portion of the blade and reduces the wear of the leading edge line portion caused by rubbing the blade on the image bearer. As a result, the present inventors found that the above-described lubricant leveling blade can prevent the occurrence of an abnormal image caused by the lubricant unevenly applied to the image bearer in a sub-scanning direction. In addition, using the blade for the electrophotography as the cleaning blade can maintain a high cleaning performance for a long time because the above-described blade is superior in preventing chipping of the edge line portion in a low-temperature environment, which is a typical side effect of a high-hardness blade.

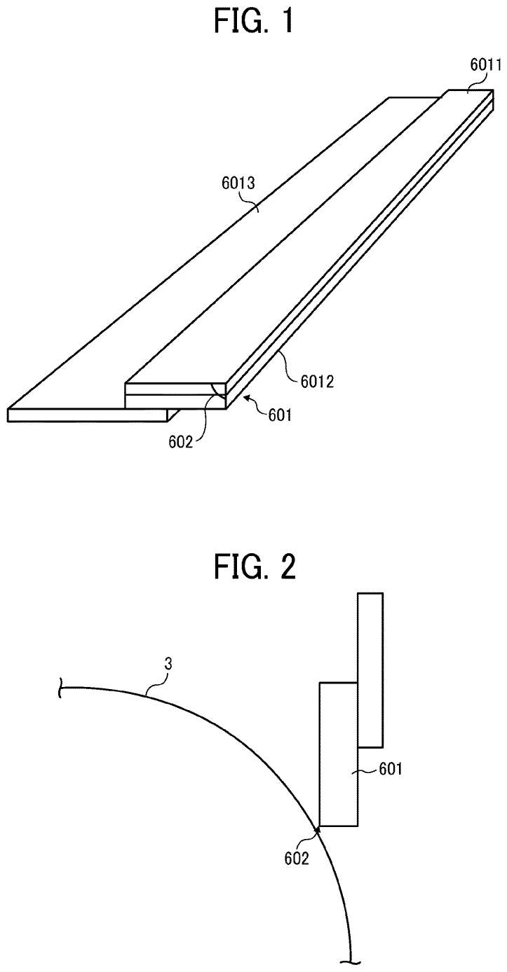

The following describes the features of the above-described blade for the electrophotography in detail with reference to the drawings. FIG. 1 is a schematic view of the blade for the electrophotography. As illustrated in FIG. 1, the blade for the electrophotography includes a flat-plate-shaped support 6013 made of a rigid material (e.g., metal, hard plastic) and a flat-plate-shaped elastic body 601. The elastic body 601 is fixed to one end of the support 6013. The elastic body 601 may have a single-layer structure or a laminated structure and includes an edge layer 6011 having the leading edge line portion and a base layer 6012. The edge layer 6011 and the base layer 6012 are typically made of urethane rubber materials having different Martens hardness values, and the base layer 6012 is made of rubber having a small environmental variation in rubber characteristics and a small permanent strain to cover the defects of the edge layer layered on the base layer. FIG. 2 is a schematic view of the blade for the electrophotography contacting the image bearer. As illustrated in FIG. 2, the blade for the electrophotography includes the elastic body 601 having a contact portion 602 contacting the surface of the image bearer such as a photoconductor 3.

### Image Bearer

The material, shape, structure, or size of the image bearer are not limited and can be suitably selected to suit a particular application. The shape of the image bearer is not limited and can be suitably selected to suit a particular application. Examples thereof include, but are not limited to, a drum shape, a belt shape, a flat plate shape, and a sheet shape. The size of the image bearer is not limited and can be suitably selected to suit a particular application. Preferably, the image bearer is in a size that is typically used. The material of the image bearer is not limited and can be suitably selected to suit a particular application. Examples thereof include, but are not limited to, metals, plastics, and ceramics.

### Elastic Body

The elastic body preferably includes an edge layer and a base layer. The edge layer has the leading edge line portion contacting the image bearer. The leading edge line portion is also referred to as the contact portion. The leading edge line portion of the elastic body contacts the image bearer and is made of polyurethane elastomer, and the Martens hardness of the leading edge line portion is 5.0 N/mm² or more and 30.0 N/mm² or less. Preferably, the elastic body has a tip edge line portion having an edge angle from 900 to 140°. The method for measuring the Martens hardness is not limited and may be appropriately selected to suit a particular application. For example, the Martens hardness may be measured using a microhardness measurement instrument (FISCHERSCOPE HM2000 available from Fischer Instruments K.K.), under conditions where a Vickers indenter is pressed into the surface of a sample with a force of 9.8 mN for 30 seconds, kept for 5 seconds, and drawn up with a force of 9.8 mN for 30 seconds. The shape, size, and structure of the elastic body are not limited and can be suitably selected to suit a particular application. The shape of the elastic body may be, for example, a flat plate shape, a strip shape, or a sheet shape. The size of the elastic body is not limited and may be appropriately selected depending on the size of the image bearer.

The polyurethane elastomer of the elastic body contains the reaction product of polytetramethylene ether glycol, aromatic isocyanate, and amine. The polytetramethylene ether glycol, the aromatic isocyanate, and the amine react with each other, and the molecules are bonded to each other by a urethane bond, which gives a cured reaction product. The cured reaction product may be referred to as a “cured product” below.

As a result of the diligent studies, the present inventors found that polytetramethylene ether glycol (PTMG) can be preferably used as the polyol component of the polyurethane elastomer. The number average molecular weight of the polytetramethylene ether glycol is not limited and may be appropriately selected to suit a particular application but is preferably from 850 to 2000. The number-average molecular weight of 850 or more and 2000 or less enables the polyurethane elastomer to have a relatively high Martens hardness of 5.0 N/mm² or more and 30.0 N/mm² or less to exhibit an elastic function.

The method for measuring the number average molecular weight is not limited and may be appropriately selected to suit a particular application. For example, the number average molecular weight may be measured by measuring components soluble in tetrahydrofuran (THF) by Gel Permeation Chromatography (GPC) under the following conditions.
GPC instrument: HLC 8120GPC manufactured by Tosoh Corporation
Columns: TSK GEL manufactured by Tosoh Corporation
Solvent: Tetrahydrofuran (THF)
Solvent concentration: 0.5% by mass
Flow rate: 1.0 ml/min

The urethane prepolymer of the elastic body is not limited and may be appropriately selected. However, as a result of intensive studies, the present inventors found that a polyurethane elastomer containing a urea bond formed by a reaction between a prepolymer in which a hydroxy group of a polyol is substituted with a bifunctional isocyanate and an aromatic diamine is preferable.

The bifunctional isocyanate is not limited and may be appropriately selected to suit a particular application. Examples thereof include, but are not limited to, dicyclohexylmethane 4,4′-diisocyanate (hydrogenated methylene diphenyl diisocyanate (MDI)), methylene diphenyl diisocyanate (MDI), tolylene diisocyanate (TDI), xylylene diisocyanate (XDI), naphthylene 1,5-diisocyanate (NDI), tetramethylxylene diisocyanate (TMXDI), isophorone diisocyanate (IPDI), hydrogenated xylylene diisocyanate (H6XDI), dicyclohexylmethane diisocyanate (H12MDI), hexamethylene diisocyanate (HDI), dimer acid diisocyanate (DDI), norbornene diisocyanate (NBDI), and trimethylhexamethylene diisocyanate (TMDI). Each of these materials can be used alone or in combination with others. Among these, tolylene diisocyanate (TDI) is preferable.

The aromatic diamine is not limited and may be appropriately selected to suit a particular application. Examples thereof include diethylmethylbenzenediamine, dimethylthiotoluenediamine, 4,4′-diaminodiphenyl ether, 2,2′-bis [4-(4-aminophenoxy) phenyl]propane, bis [4-(4-aminophenoxy) phenyl]sulfone, 1, 3-bis(4-aminophenoxy) benzene, 4,4′-diaminodiphenyl sulfone, 4,4′-methylene-bis (2-chloroaniline), and trimethylene-bis (4-aminobenzoate). Each of these materials can be used alone or in combination with others. Among these, dimethylthiotoluenediamine is preferable.

A method for preparing the polyurethane elastomer is not limited and may be appropriately selected to suit a particular application. For example, the polyurethane elastomer can be prepared by substituting a hydroxy group of a polyether polyol with a bifunctional isocyanate to prepare a polyurethane prepolymer, adding an aromatic diamine to the polyurethane prepolymer, and reacting an NCO group of the prepolymer with an amino group of the aromatic diamine as a curing agent to form a urea bond.

The tan δ peak temperature of the polyurethane elastomer is not limited and may be appropriately selected to suit a particular application, but is preferably from 60 °C to 120 °C. Setting the tan δ peak temperature to be from 60 °C to 120 °C is less likely to cause the change in the Martens hardness and the friction coefficient in the temperature range in which the electrophotographic system is used and stabilizes the function of the elastic body.

A method for measuring the tan δ peak temperature is not limited and may be appropriately selected to suit a particular application. For example, the tan δ peak temperature can be measured by using a DMS6100 manufactured by Hitachi High-Tech Science Corporation in a frequency-division 10 Hz.

The material of the base layer of the elastic body is not limited and can be suitably selected to suit a particular application. Preferred examples thereof include polyurethane elastomer that can easily achieve high elasticity. The polyurethane elastomer of the base layer can be manufactured as follows. First, a polyurethane prepolymer is prepared from a polyol compound and a polyisocyanate compound, then a curing agent is added thereto, optionally along with a curing catalyst, to cause a cross-linking reaction in a predetermined mold. Next, the product is post-cross-linked in a furnace, formed into a sheet by centrifugal molding, left at room temperature for aging, and cut into a flat plate having a predetermined size.

The polyol compound is not limited and may be suitably selected to suit a particular application. Examples thereof include, but are not limited to, high-molecular-weight polyols and low-molecular-weight polyols. The high-molecular-weight polyol has a molecular weight of 500 or more, and Specific examples of the high-molecular-weight polyols include, but are not limited to, a polyester polyol which is a condensate of an alkylene glycol and an aliphatic diprotic acid; polyester-based polyols, such as polyester polyols of alkylene glycols with adipic acid, such as ethylene adipate ester polyol, butylene adipate ester polyol, hexylene adipate ester polyol, ethylene propylene adipate ester polyol, ethylene butylene adipate ester polyol, and ethylene neopentylene adipate ester polyol; polycaprolactone-based polyols such as polycaprolactone ester polyols obtained by ring-opening polymerization of caprolactone; and polyether-based polyols such as poly(oxytetramethylene) glycol and poly(oxypropylene) glycol. Each of these materials can be used alone or in combination with others.

The low-molecular-weight polyol has a molecular weight of less than 500. Specific examples of the low-molecular-weight polyols include, but are not limited to, trivalent or more polyhydric alcohols such as 1,4-butanediol, ethylene glycol, neopentyl glycol, hydroquinone-bis(2-hydroxyethyl) ether, 3,3′-dichloro-4,4′-diaminodiphenylmethane, and 4,4′-diaminodiphenylmethane; and trivalent or higher polyols such as 1,1,1-trimethylolpropane, glycerin, 1,2,6-hexanetriol, 1,2,4-butanetriol, trimethylolethane, 1,1,1-tris(hydroxyethoxymethyl)propane, diglycerin, and pentaerythritol. Each of these materials can be used alone or in combination with others.

The polyisocyanate compound is not limited and may be suitably selected to suit a particular application. Specific examples thereof include, but are not limited to, methylene diphenyl diisocyanate (MDI), tolylene diisocyanate (TDI), xylylene diisocyanate (XDI), naphthylene 1,5-diisocyanate (NDI), tetramethylxylene diisocyanate (TMXDI), isophorone diisocyanate (IPDI), hydrogenated xylylene diisocyanate (H6XDI), dicyclohexylmethane diisocyanate (H12MDI), hexamethylene diisocyanate (HDI), dimer acid diisocyanate (DDI), norbornene diisocyanate (NBDI), and trimethylhexamethylene diisocyanate (TMDI). Each of these materials can be used alone or in combination with others.

The curing catalyst is not limited and may be suitably selected to suit a particular application. Specific examples thereof include, but are not limited to, 2-methylimidazole and 1,2-dimethylimidazole. The proportion of the curing catalyst to the polyurethane prepolymer is not limited and may be suitably selected to suit a particular application, but is preferably from 0.01% to 0.5% by mass, more preferably from 0.05% to 0.3% by mass.

The Martens hardness of the base layer is not limited and may be suitably selected to suit a particular application but is preferably from 0.5 N/mm² to 2.0 N/mm². When the Martens hardness of the base layer is 0.5 N/mm² or more, the hardness of the base layer is appropriate, and the base layer is easily cut after centrifugal molding. The base layer having the Martens hardness of 2.0 N/mm² or less has a small environmental change and a small permanent set.

The method for measuring the Martens hardness is not limited and may be appropriately selected to suit a particular application. For example, the Martens hardness may be measured by using a microhardness measurement instrument HM2000 available from Fischer Instruments K.K.

The base layer is not limited and may be suitably selected to suit a particular application, but a laminate of two or more types of rubbers having different Martens hardness values, integrated by molding, is preferred for achieving both wear resistance and conformability.

The average thickness of the blade for the electrophotography is not limited and may be appropriately selected depending on the intended purpose, but is preferably from 1.0 mm to 2.5 mm.

### Support

The shape, size, and material of the support are not limited and may be suitably selected to suit a particular application. The shape of the support is not limited and may be suitably selected to suit a particular application. Examples of the shape of the support include, but are not limited to, a flat plate shape, a strip shape, or a sheet shape. The size of the support is not limited and may be suitably selected according to the size of the image bearer. The material of the support is not limited and may be suitably selected to suit a particular application. Examples of the material include, but are not limited to, metals, plastics, and ceramics. Among these, metal plates such as steel plates (e.g., stainless steel plates), aluminum plates, and phosphor bronze plates are preferred for their strength.

### Lubricant

The lubricant is not limited and may be suitably selected to suit a particular application. Examples of the lubricant include, but are not limited to, lamellar crystal powder such as zinc stearate, fatty acid salt, wax, and silicone oil. Among these, lamellar crystal powder is preferable.

The lamellar crystal powder has a layered structure in which amphiphilic molecules are self-organized. When a shear force is applied thereto, it is likely that crystals are broken and separated along the layers. This feature is considered to be effective in reducing the friction coefficient. The lamellar crystal powder is not limited and may be suitably selected to suit a particular application. Examples of the lamellar crystal powder include, but are not limited to, zinc stearate.

The fatty acid is not limited and may be suitably selected to suit a particular application. Examples of the fatty acid include, but are not limited to, undecylic acid, lauric acid, tridecylic acid, myristic acid, palmitic acid, pentadecyl acid, stearic acid, heptadeccylic acid, arachic acid, montanic acid, oleic acid, arachidonic acid, caprylic acid, capric acid, or caproic acid. The fatty acid may be fatty acid metal salt. The metal is not limited and may be suitably selected to suit a particular application. Examples of the metal include, but are not limited to, zinc, iron, copper, magnesium, aluminum, and calcium.

### Image Forming Apparatus and Image Forming Method

The image forming apparatus in the present disclosure includes at least an image bearer, a charger, an irradiator, a developing device, a transferor, a fixing device, a remover, and optionally a lubricant leveling device, and another device suitably selected. The charger and the irradiator may be collectively referred to as an electrostatic latent image forming device. The image forming method used in the present disclosure includes at least a charging process, an exposure process, a developing process, a transfer process, a fixing process, and a removing process and optionally includes other processes such as a lubricant leveling process. The charging process and the exposure process may be collectively referred to as an electrostatic latent image forming process. The image forming apparatus according to the present disclosure can suitably perform the image forming method according to the present disclosure. The charger can perform the charging process. The irradiator can perform the exposure process. The developing device can perform the developing process. The transferor can perform the transfer process. The fixing device can perform the fixing process. The remover can perform the removing process. The other processes can be performed by the other corresponding devices.

The electrostatic latent image bearer, which is also referred to as an electrophotographic photoconductor or a photoconductor in the following description, is not limited in material, shape, structure, and size, and can be appropriately selected from known materials. As the shape, drum-like shape is preferred. Specific examples of the materials include, but are not limited to, inorganic photoconductors such as amorphous silicon and selenium, and organic photoconductors such as polysilane and phthalopolymethine. As the organic photoconductor, one such photoconductor includes a laminated type photoconductor having a laminated structure containing a layer (charge generation layer) in which charge-generating materials such as non-metallic phthalocyanine or titanyl phthalocyanine are dispersed in a binder resin and a layer (charge transport layer) in which charge transport materials are dispersed in a binder resin. These layers are stacked on a support such as an aluminum drum. Another example is a single-layer type photoconductor having a single-layer structure with a photosensitive layer containing both charge-generating materials and charge transport materials dispersed in a binder resin on a support. In the single-layer type photoconductor, it is also possible to add hole transport agents and electron transport agents as charge transport materials to the photosensitive layer. Additionally, the option exists to include an undercoat layer between the substrate and either the charge-generating layer in the laminate photoconductor or the photosensitive layer in the single-layer photoconductor

### Charger and Charging Process

In the charging process, the charger charges the surface of the image bearer. A voltage is applied to the charger, and the charger charges the surface of the image bearer in the charging process. The charger is not limited and may be suitably selected to suit a particular application. Examples of the charger include, but are not limited to, contact chargers equipped with a conductive or semiconductive roller, brush, film, or rubber blade, and non-contact chargers employing corona discharge such as corotron and scorotron.

The shape of the charger is determined in accordance with the specification or configuration of the electrophotographic image forming apparatus, and may be in the form of a roller, a magnetic brush, or a fur brush. The magnetic brush may include various ferrite particles (e.g., Zn—Cu ferrite) serving as the charger, a non-magnetic conductive sleeve for supporting the ferrite particles, and a magnet roll contained inside the conductive sleeve. The fur brush may be made of fur having been subjected to a conductive treatment with carbon, copper sulfide, a metal, or a metal oxide. Such fur is wound around or attached to a metal cored bar or a cored bar having been subjected to a conductive treatment to be formed into the charger.

The charger is not limited to the contact charger. However, the contact charger is preferred because the amount of by-product ozone is small. Preferably, the charger is disposed in or out of contact with the image bearer and capable of charging the surface of the image bearer by applying direct-current and alternating-current voltages in superimposition thereto. Preferably, the charger is a charging roller disposed close to but out of contact with the image bearer via a gap tape and capable of charging the surface of the image bearer by applying direct-current and alternating-current voltages in superimposition thereto.

### Irradiator and Exposure Process

In the exposure process, the irradiator exposes the charged surface of the image bearer. The irradiator irradiates the surface of the image bearer with light to form an electrostatic latent image. The optical system in the irradiator is roughly divided into an analog optical system and a digital optical system. The analog optical system directly projects an original document onto the surface of the image bearer. The digital optical system receives image data as electrical signals, converts the electrical signals into optical signals, and irradiates the electrophotographic photoconductor as the image bearer with the optical signals to form the image. As for the irradiator, as long as it is capable of exposing the charged image bearer to form a latent electrostatic image, there is no particular limitation, and various irradiators such as a copying optical system, a rod lens array system, a laser optical system, a liquid crystal shutter optical system, and an LED optical system can be selected to suit a particular application. The exposure process can also be conducted by irradiating the back surface of the image bearer with light to form the image.

### Developing Process and Developing Device

In the developing process, the developing device develops the electrostatic latent image with toner to form a visible image. The developing device is not limited in configuration so long as the developing device can develop the electrostatic latent image with the toner. The developing device may be selected from known developing devices that store the toner and develop the electrostatic latent image by a contact developing method or a non-contact developing method.

The developing device may employ either a dry developing method or a wet developing method. The developing device may be either a monochrome developing device or a multicolor developing device. Preferably, the developing device includes a stirrer that stirs developer to triboelectrically charge the toner and a rotatable magnet roller. In the developing device, toner particles and carrier particles are mixed and stirred. The toner particles are charged by friction and retained on the surface of the rotating magnet roller, thus forming a magnetic brush. The magnet roller is disposed proximity to the electrostatic latent image bearer, so that a part of the toner particles composing the magnetic brush formed on the surface of the magnet roller are moved to the surface of the electrostatic latent image bearer by electric attractive force. As a result, the electrostatic latent image is developed with the toner particles and a toner image is formed with the toner particles on the surface of the electrostatic latent image bearer. The toner contained in the developing device may be a developer containing the toner, and the developer may be either a one-component developer or a two-component developer.

### Transfer Process and Transferor

In the transfer process, the transferor transfers the toner image onto a recording medium. Examples of the transfer process include an intermediate transfer process. The intermediate transfer process includes a primary transfer process and a secondary transfer process. In the primary transfer process, primary transferors sequentially transfer the toner images formed on the image bearers to an intermediate transferor to form a full-color toner image on the intermediate transferor. In the secondary transfer process, the secondary transferor transfers the full-color toner image from the intermediate transferor to the recording medium. The transfer process is not limited to the intermediate transfer process and may be a direct transfer process. Examples of the transferors including the primary transferor and the secondary transferor include a corona discharger, a transfer belt, a transfer roller, a pressure transfer roller, and an adhesive transferor. The recording medium is not limited and may be an overhead projector (OHP) sheet in addition to a sheet of plain paper.

### Fixing Process and Fixing Device

In the fixing process, the fixing device fixes the toner transferred to the recording medium onto the recording medium. For example, the fixing device includes a heater, a fixing belt, and a pressure roller. The heater heats the fixing belt to a fixing target temperature in a range from 80 °C to 200 °C. The pressure roller is pressed against the fixing belt to form a fixing nip. The recording medium passes through the fixing nip, and heat and pressure are applied to the toner on the recording medium to fix the toner onto the recording medium. Various types of fixing devices exist and are used.

Removing process and Remover

In the removing process, the remover suitably removes the toner remaining on the image bearer. As the remover, the cleaning blade is used. The elastic body of the cleaning blade preferably contacts the image bearer at a pressing force of 10 N/m or more and 100 N/m or less. The pressing force that is 10 N/m or more is less likely to cause cleaning failure due to toner passing through the contact portion at which the elastic body of the cleaning blade contacts the image bearer. The pressing force that is 100 N/m or less prevents the friction force at the contact portion from increasing and prevents the cleaning blade from turning up. The pressing force is preferably 10 N/m to 50 N/m. The pressing force can be measured using, for example, a measuring apparatus incorporating a small compression load cell available from KYOWA ELECTRONIC INSTRUMENTS CO., LTD. An angle (that is a cleaning angle) θ formed by an end surface of the cleaning blade and a tangent line at the contact portion at which the elastic body of the cleaning blade comes into contact with the surface of the image bearer is not limited and may be appropriately selected depending on the intended purpose but is preferably 65° or more and 85° or less. The angle θ that is 65° or more prevents the cleaning blade from turning up, and the angle that is 850 or less prevents the occurrence of the cleaning failure.

In the lubricant leveling process, the lubricant leveling device applies lubricant to the surface of the image bearer to level the lubricant. The application of the lubricant can be performed by molding the lubricant into a solid shape, pressing the solid lubricant against a fur brush using a pressure spring, rotating the fur brush to apply the lubricant to the surface of the image bearer, and then uniformly applying the lubricant using a lubricant leveling blade.

### Other Processes and Other Devices

The other devices may include, for example, a neutralizer, a recycler, and a controller.

The other processes may include, for example, a neutralization process, a recycling process, and a control process.

### Neutralization Process and Neutralizer

In the neutralization process, the neutralizer such as a neutralization lamp uniformly reduces the electric potential of the image bearer. The neutralizer is not limited to the neutralization lamp and may be a corona discharger.

### Recycling Process and Recycler

In the recycling process, the recycler recycles the toner removed in the removing process to the developing device. The recycler is not limited and may be a conveyor.

### Control Process and Controller

In the control process, the controller controls the above-described processes.

The controller is not particularly limited and can be suitably selected to suit a particular application as long as it is capable of controlling the above-described processes. Specific examples of the controller include, but are not limited to, a sequencer and a computer.

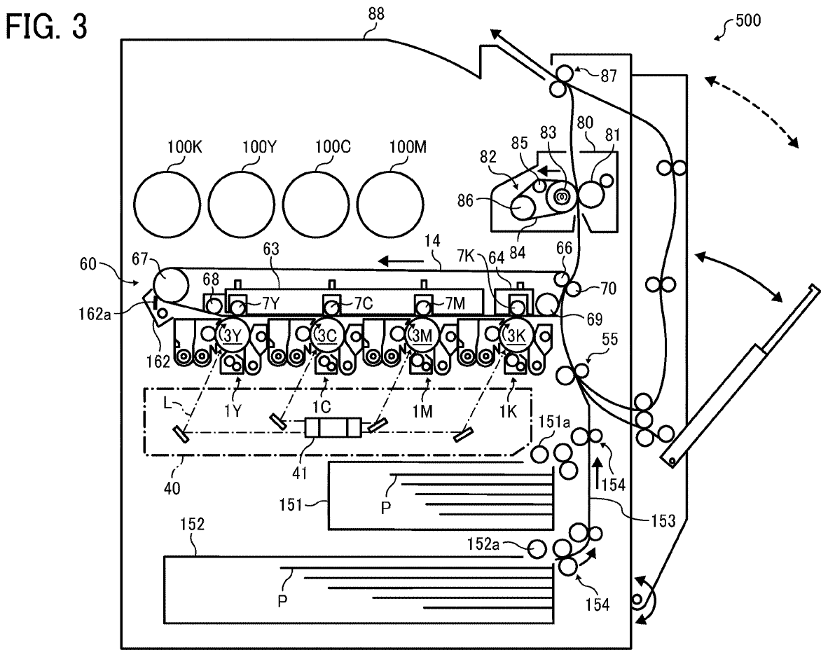

An image forming apparatus according to an embodiment of the present disclosure is described below with reference to the drawings. FIG. 3 is a schematic diagram illustrating a configuration of the image forming apparatus. The image forming apparatus 500 includes four image forming units 1Y, 1C, 1M, and 1K for forming yellow, cyan, magenta, and black images, respectively. The image forming units 1Y, 1C, 1M, and 1K have the same configuration except for storing different color toners, i.e., yellow, cyan, magenta, and black toners, respectively, as image forming materials. Above the four image forming units 1Y, 1C, 1M, and 1K, which are collectively described as image forming units 1 below, a transfer unit 60 is disposed. The transfer unit 60 includes an intermediate transfer belt 14 as the intermediate transferor. The image forming units 1Y, 1C, 1M, and 1K include photoconductors 3Y, 3C, 3M, and 3K, respectively, on which toner images with colors are to be formed. The toner images are superimposed on top of one another on a surface of the intermediate transfer belt 14. Below the four image forming units 1, an optical writing unit 40 is disposed. The optical writing unit 40, serving as a latent image forming device, emits laser light L based on image data to the photoconductors 3Y, 3C, 3M, and 3K in the image forming units 1Y, 1C, 1M, and 1K. Thus, electrostatic latent images for yellow, cyan, magenta, and black images are formed on the photoconductors 3Y, 3C, 3M, and 3K, respectively. In the optical writing unit 40, the laser light L is emitted from a light source, deflected by a polygon mirror 41 that is driven and rotated by a motor, and directed to the photoconductors 3Y, 3M, 3C, and 3K through multiple optical lenses and mirrors. Alternatively, the optical writing unit 40 may be replaced with another unit in which a light-emitting diode (LED) array performs optical scanning.

Below the optical writing unit 40, a first sheet feed tray 151 and a second sheet feed tray 152 are disposed so as to overlap in the vertical direction. In each sheet feed tray, multiple recording media P are stacked on top of one another. The top one of the recording media P in each sheet feed tray is in contact with a first sheet feeding roller 151a or a second sheet feeding roller 152a. As the first sheet feeding roller 151a is rotated counterclockwise in FIG. 3 by a driver, the top one of the recording media P in the first sheet feed tray 151 is fed to a sheet feeding path 153 that is vertically extended on the right side of the sheet feed trays in FIG. 3. As the second sheet feeding roller 152a is rotated counterclockwise in FIG. 3 by a driver, the top one of the recording media P in the second sheet feeding tray 152 is fed to the sheet feeding path 153.

On the sheet feeding path 153, multiple conveyance roller pairs 154 are disposed. The recording medium P fed to the sheet feeding path 153 is conveyed upward in FIG. 3 inside the sheet feeding path 153 while being nipped by the rollers of the conveyance roller pairs 154. On a downstream end of the sheet feeding path 153 relative to the direction of conveyance of the recording medium P, a registration roller pair 55 is disposed. Immediately after the rollers of the registration roller pair 55 nip the recording medium P fed by the conveyance roller pairs 154, the registration roller pair 55 stops rotating. The registration roller pair 55 then timely feeds the recording medium P to a secondary transfer nip, which is described below.

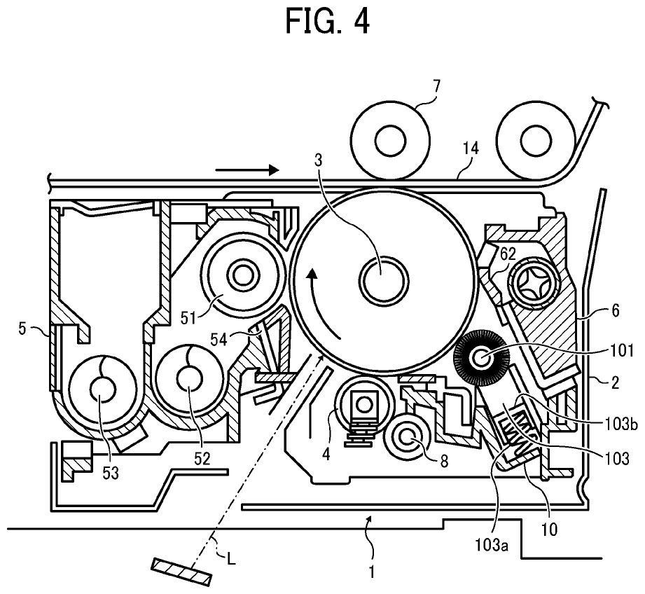

FIG. 4 is a schematic diagram illustrating a configuration of one of image forming units in the image forming apparatus of FIG. 3. As illustrated in FIG. 4, each of the image forming units 1 includes the drum-shaped photoconductor 3 serving as the image bearer. The photoconductor 3 has a drum shape but may have a sheet shape or an endless belt shape.

Around the photoconductor 3, a charging roller 4, a developing device 5, a primary transfer roller 7, a cleaner 6, a lubricant leveling device 10, and a neutralization lamp are disposed. The charging roller 4 is a charging member of the charger. The developing device 5 develops an electrostatic latent image formed on a surface of the photoconductor 3 into a toner image. The primary transfer roller 7 is a primary transferor of the primary transfer device that transfers the toner image from the surface of the photoconductor 3 onto the intermediate transfer belt 14. The cleaner 6 is the remover that removes residual toner particles remaining on the photoconductor 3 after the toner image has been transferred therefrom onto the intermediate transfer belt 14. The lubricant leveling device 10 applies the lubricant to the surface of the photoconductor 3 having been cleaned by the cleaner 6 and levels the lubricant on the surface of the photoconductor 3. The neutralization lamp is a neutralizer configured that reduces the surface potential of the photoconductor 3 having been cleaned.

The charging roller 4 is disposed at a predetermined distance from the photoconductor 3 without contacting the photoconductor 3. The charging roller 4 charges the photoconductor 3 to a predetermined potential with a predetermined polarity. After the charging roller 4 has uniformly charged the surface of the photoconductor 3, the optical writing unit 40 emits the laser light L to the charged surface of the photoconductor 3 based on image data to form the electrostatic latent image. The developing device 5 includes a developing roller 51 serving as a developer bearer. A power supply applies a developing bias to the developing roller 51. In the casing of the developing device 5, a supply screw 52 and a stirring screw 53 are provided for stirring the developer contained in the casing while conveying the developer in opposite directions. Also, a doctor 54 for regulating the developer carried on the developing roller 51 is disposed within the casing. As the developer is stirred and conveyed by the supply screw 52 and the stirring screw 53, toner particles in the developer are charged to have a predetermined polarity. The developer is then carried on the surface of the developing roller 51 and regulated by the doctor 54. Toner particles in the developer adhere to a latent image formed on the photoconductor 3 at a developing region where the developing roller 51 faces the photoconductor 3.

The cleaner 6 includes a fur brush 101 and a cleaning blade 62. The cleaning blade 62 according to the present disclosure is in contact with the photoconductor 3 so as to face in the direction of movement of the surface of the photoconductor 3. The charger employs a non-contact proximity arrangement system in which the charging roller 4 is disposed in proximity to the photoconductor 3 without contacting the photoconductor 3. Alternatively, any known charger such as a corotron, a scorotron, and a solid-state charger can also be used as the charger. Among these charging systems, contact charging systems and non-contact proximity arrangement systems are preferred, since they have advantages in terms of high charging efficiency, less generation of ozone, and compact size.

Examples of the light source of the optical writing unit 40 that emits the laser light L and the light source of the neutralization lamp include all luminous matters such as fluorescent lamp, tungsten lamp, halogen lamp, mercury lamp, sodium-vapor lamp, light-emitting diode (LED), laser diode (LD), and electroluminescence (EL). For the purpose of emitting only light having a desired wavelength, any type of filter can be used, such as a sharp cut filter, band pass filter, near-infrared cut filter, dichroic filter, interference filter, and color-temperature conversion filter. Among these light sources, light-emitting diode and semiconductor laser are preferred since they can emit long-wavelength light (600 to 800 nm) with high energy.

Referring to FIG. 3, the transfer unit 60 serving as the transferor further includes, in addition to the intermediate transfer belt 14, a belt cleaning unit 162, a first bracket 63, and a second bracket 64. The transfer unit 60 further includes four primary transfer rollers 7Y, 7M, 7C, and 7K, a secondary transfer backup roller 66, a driving roller 67, an auxiliary roller 68, and a tension roller 69. The intermediate transfer belt 14 is stretched taut with these eight rollers, and the driving roller 67 rotates to rotate the intermediate transfer belt 14 counterclockwise in FIG. 3. The four primary transfer rollers 7Y, 7M, 7C, and 7K nip the intermediate transfer belt 14 together with the four photoconductors 3Y, 3M, 3C, and 3K to form the four primary transfer nips between the intermediate transfer belt 14 and the photoconductors 3Y, 3M, 3C, and 3K, respectively. The back surface (i.e., an inner circumferential surface of the loop) of the intermediate transfer belt 14 is then applied with a transfer bias having the opposite polarity to the toner (e.g., positive polarity). As the intermediate transfer belt 14 rotates while sequentially passing the primary transfer nips for yellow, cyan, magenta, and black, the toner images of yellow, cyan, magenta, and black formed on the photoconductors 3Y, 3C, 3M, and 3K are superimposed on one another on the outer circumferential surface of the intermediate transfer belt 14. Thus, a composite toner image in which four color toner images are superimposed on one another is formed on the intermediate transfer belt 14.

The intermediate transfer belt 14 is interposed between a secondary transfer roller 70 disposed outside the loop of the intermediate transfer belt 14 and the secondary transfer backup roller 66 to form a secondary transfer nip. The above-described registration roller pair 55 feeds the recording medium P to the secondary transfer nip in synchronization with an entry of the composite toner image on the intermediate transfer belt 14 into the secondary transfer nip. The composite toner image on the intermediate transfer belt 14 is secondarily transferred onto the recording medium P in the secondary transfer nip by the actions of a secondary transfer electric field and the nip pressure. The secondary transfer electric field is formed between the secondary transfer roller 70 to which a secondary transfer bias is applied and the secondary transfer backup roller 66. The composite toner image is combined with the white color of the recording medium P to generate a full-color image.

On the intermediate transfer belt 14 having passed through the secondary transfer nip, residual toner particles that have not been transferred onto the recording medium P remain. These residual toner particles are removed by the belt cleaning unit 162. The belt cleaning unit 162 includes a belt cleaning blade 162a in contact with the outer circumferential surface of the intermediate transfer belt 14. The belt cleaning blade 162a scrapes off the residual toner particles from the intermediate transfer belt 14. The first bracket 63 of the transfer unit 60 is swingable about the rotation axis of the auxiliary roller 68 at a predetermined angle in accordance with the on/off driving operation of a solenoid. When the image forming apparatus 500 forms a black-and-white image, the solenoid is driven to slightly rotate the first bracket 63 counterclockwise in FIG. 3. This rotation of the first bracket 63 revolves the primary transfer rollers 7Y, 7C, and 7M counterclockwise in FIG. 3 about the rotation axis of the auxiliary roller 68 to bring the intermediate transfer belt 14 away from the photoconductors 3Y, 3C, and 3M. Thus, among the four image forming units 1Y, 1M, 1C, and 1K, only the image forming unit 1K for black image is brought into operation to form the black-and-white image. Since unnecessary driving of the image forming units 1Y, 1C, and 1M is avoided during the formation of the black-and-white image, undesired deterioration of compositional members of the image forming units 1Y, 1C, and 1M can be prevented.

Above the secondary transfer nip in FIG. 3, a fixing unit 80 is disposed. The fixing unit 80 includes a pressure heating roller 81 and a fixing belt unit 82. The pressure heating roller 81 contains a heat source, such as a halogen lamp, inside. The fixing belt unit 82 includes a fixing belt 84 serving as a fixing member, a heating roller 83, a tension roller 85, a driving roller 86, and a temperature sensor. The heating roller 83 contains a heat source, such as a halogen lamp, inside. The fixing belt 84 having an endless-belt form is stretched taut with the heating roller 83, the tension roller 85, and the driving roller 86 and rotates counterclockwise in FIG. 3. While the fixing belt 84 rotates, the heating roller 83 heats the inner circumferential face of the fixing belt 84. At a position where the fixing belt 84 is wound around the heating roller 83, the pressure heating roller 81 contacts the outer circumferential surface of the fixing belt 84. The pressure heating roller 81 is driven to rotate clockwise in FIG. 3. Thus, the pressure heating roller 81 and the fixing belt 84 form a fixing nip therebetween.

The temperature sensor is disposed outside the loop of the fixing belt 84 facing the outer circumferential surface of the fixing belt 84 forming a predetermined gap therebetween. The temperature sensor detects the surface temperature of the fixing belt 84 immediately before entering into the fixing nip. The detection result is transmitted to a fixing power supply circuit. Based on the detection result, the fixing power supply circuit controls power supplies supplying power to the heat sources contained in the heating roller 83 and the pressure heating roller 81 to turn on or off the power supplies. The recording medium P having passed through the secondary transfer nip is then separated from the intermediate transfer belt 14 and fed to the fixing unit 80. The recording medium P is fed upward in FIG. 3 while being sandwiched by the fixing nip in the fixing unit 80. During this process, the recording medium P is heated and pressurized by the fixing belt 84, and the full-color toner image is fixed on the recording medium P.

The recording medium P having the fixed image thereon is passed through an ejection roller pair 87 and ejected outside the image forming apparatus 500. On the top surface of the housing of the image forming apparatus 500, a stack part 88 is formed. The recording media P ejected by the ejection roller pair 87 are successively stacked on the stack part 88. Above the transfer unit 60, four toner cartridges 100Y, 100C, 100M, and 100K storing yellow toner, cyan toner, magenta toner, and black toner, respectively, are disposed. The yellow, cyan, magenta, and black toners, which are stored in the toner cartridges 100Y, 100C, 100M, and 100K, respectively, are supplied to the developing devices 5Y, 5C, 5M, and 5K in the image forming units 1Y, 1C, 1M, and 1K. The toner cartridges 100Y, 100M, 100C, and 100K are detachably mountable on the image forming apparatus main body independent from the image forming units 1Y, 1M, 1C, and 1K.

An image forming operation of the image forming apparatus 500 is described below. In response to receipt of a print execution signal from an operation panel, the charging roller 4 and the developing roller 51 each get applied with a predetermined voltage or current at a predetermined timing. Similarly, the light sources in the optical writing unit 40 and the neutralization lamp each get applied with a predetermined voltage or current at a predetermined timing. In synchronization with the application of voltage or current, the photoconductor 3 is driven to rotate in a direction indicated by arrow in FIG. 3 by a photoconductor driving motor. As the photoconductor 3 rotates in a direction indicated by arrow in FIG. 3, the charging roller 4 uniformly charges the surface of the photoconductor 3 to a predetermined potential. The optical writing unit 40 emits the laser light L to the charged surface of the photoconductor 3 based on image data to reduce the electric potential of a part of the surface of the photoconductor 3 irradiated with the laser light L, thereby forming an electrostatic latent image. The surface of the photoconductor drum 3 bearing the electrostatic latent image thereon reaches a position opposite the developing device 5, and a magnetic brush formed by the developer on the developing roller 51 rubs the surface of the photoconductor 3 at the position opposite the developing device 5. As a developing bias is applied to the developing roller 51, negatively-charged toner particles on the developing roller 51 are transferred onto the electrostatic latent image, thus forming a toner image. This image forming process is performed in each of the image forming units 1Y, 1C, 1M, and 1K to form yellow, cyan, magenta, and black toner images on the photoconductors 3Y, 3C, 3M, and 3K, respectively.

Thus, in the image forming apparatus 500 employing a reversal development system, the developing device 5 develops the electrostatic latent image formed on the photoconductor 3 with negatively charged toner particles. In the present embodiment, an N/P (i.e., negative/positive) development system (in which toner particles get adhered to low-potential regions) and a non-contact charging roller are employed, but the development and charging systems are not limited thereto. The toner images formed on the photoconductors 3Y, 3C, 3M, and 3K are primarily transferred onto the surface of the intermediate transfer belt 14 in a sequential manner so that the toner images are superimposed on top of one another on the surface of the intermediate transfer belt 14. Thus, the composite toner image is formed on the intermediate transfer belt 14. The composite toner image (“toner image” for simplicity) formed on the intermediate transfer belt 14 is transferred onto the recording medium P which has been fed from the first sheet feed tray 151 or the second sheet feed tray 152, passed through the registration roller pair 55, and fed to the secondary transfer nip. The recording medium P is temporarily stopped by being sandwiched by the registration roller pair 55, and then fed to the secondary transfer nip in synchronization with an entry of the leading end of the toner image on the intermediate transfer belt 14 into the secondary transfer nip. The recording medium P having the transferred toner image thereon is then separated from the intermediate transfer belt 14 and fed to the fixing unit 80. As the recording medium P having the transferred toner image thereon passes through the fixing unit 80, the toner image is fixed on the recording medium P by heat and pressure. The recording medium P having the fixed toner image thereon is ejected outside the image forming apparatus 500 and stacked at the stack part 88.

On the other hand, after the toner image has been transferred from the surface of the intermediate transfer belt 14 onto the recording medium P in the secondary transfer nip, the belt cleaning unit 162 removes residual toner particles remaining on the surface of the intermediate transfer belt 14. Similarly, after the toner image has been transferred from the surface of the photoconductor 3 onto the intermediate transfer belt 14 in the primary transfer nip, the cleaner 6 removes residual toner particles remaining on the surface of the photoconductor 3. The lubricant leveling device 10 then applies the lubricant to the cleaned surface, and the neutralization lamp further reduces the electric potential on the surface.

As illustrated in FIG. 4, each of the image forming units 1 of the image forming apparatus 500 has a frame body 2 accommodating the photoconductor 3 and processing devices including the charging roller 4, the developing device 5, the cleaner 6, and the lubricant leveling device 10. Each of the image forming units 1 is detachably attached to the body of the image forming apparatus 500 as one unit that is a process cartridge. Thus, in the image forming apparatus 500, the photoconductor 3 and the processing devices are replaceable at the same time by replacing each of the image forming units 1 as the process cartridge. Alternatively, each of the photoconductor 3, the charging roller 4, the developing device 5, the cleaner 6, and the lubricant leveling device 10 may be independently replaceable.

As the toner used in the image forming apparatus 500, polymerization toner is preferable to enhance image quality. The polymerization toner is produced by a suspension polymerization method, an emulsion polymerization method, or a dispersion polymerization method, which make it easy to make the toner highly circular and small in particle size. Among the above-described types of polymerization toner, polymerization toner having a volume average particle diameter of 5.5 m or less is preferable from the viewpoint of forming a high-resolution image.

The blade for the electrophotography can be produced by production methods such as a sheet forming method or a direct forming method.

The sheet forming method includes the following procedures (1) and (2).
(1) A reaction composition liquid is cast into a sheet shape and cured by reaction to form a raw sheet, and the raw sheet is cut in a cutting process to form the blade. To form the sheet shape, a centrifugal molding method is typically used.
(2) The blade is attached to a support such as a metal plate for mounting the blade on the image forming apparatus by adhesion to form a blade unit.

The direct forming method includes the following procedures.

The support such as the metal plate for mounting the blade on the image forming apparatus is disposed in a mold having a cavity in the shape of the blade to be molded, and the reaction composition liquid is cast into the molding cavity to mold the blade and form the blade unit.

### EXAMPLES

Further understanding of the present disclosure can be obtained by reference to certain specific Examples and Comparative Examples provided herein below for the purpose of illustration only and are not intended to be limiting. In the descriptions in the following examples, the numbers in parts represent mass ratios in parts, and “%” represents “% by mass,” unless otherwise specified.

### (Base Layer Production Example 1)

A base layer example 1 was made from urethane rubber A as a material by the centrifugal molding so that the base layer 1 made from polyurethane elastomer has the following values of the film thickness and the Martens hardness measured by the following methods.
Film Thickness: 0.9 mm
Martens Hardness: 0.60 N/mm²

### —Method for Measuring Martens Hardness—

The Martens hardness was measured using a microhardness measurement instrument (FISCHERSCOPE HM2000 available from Fischer Instruments K.K.), under conditions where a Vickers indenter is pressed into the surface of sample with a force of 9.8 mN for 30 seconds, kept for 5 seconds, and drawn up with a force of 9.8 mN for 30 seconds.

### —Method for Measuring Film Thickness—

VHX 8000 (manufactured by KEYENCE) was used to measure the film thickness of the base layer. Five points on the cross section of the base layer were measured, and the average value was calculated as the film thickness of the base layer.

### (Base Layer Production Example 2)

A base layer example 2 was produced in the same manner as in Base Layer Production Example 1 except that the urethane rubber A as a material was changed to the urethane rubber B. The film thickness and the Martens hardness were measured in the same manner as in Base Layer Production Example 1, and the following values were obtained.
Film Thickness: 0.9 mm
Martens hardness: 2.00 N/mm²

### (Base Layer Production Example 3)

A base layer example 3 was produced in the same manner as in Base Layer Production Example 1 except that the urethane rubber A as a material was changed to the urethane rubber C. The film thickness and the Martens hardness were measured in the same manner as in Base Layer Production Example 1, and the following values were obtained.
Film Thickness: 0.9 mm
Martens hardness: 1.50 N/mm²

### (Base Layer Production Example 4)

A base layer example 4 was produced in the same manner as in Base Layer Production Example 1 except that the urethane rubber A as a material was changed to the urethane rubber D. The film thickness and the Martens hardness were measured in the same manner as in Base Layer Production Example 1, and the following values were obtained.
Film Thickness: 0.9 mm
Martens hardness: 1.00 N/mm²

### (Edge Layer Production Example 1)

ETHACURE 300 (that is dimethylthiotoluenediamine:DMTDA) as curing agent was added to 100 parts by mass of TAKENATE L-2360 manufactured by Mitsui Chemicals, Inc. and stirred to prepare an edge layer forming liquid. The edge layer has the contact portion of the blade. Accordingly, the edge layer forming liquid may be referred to as a contact portion forming liquid. The edge layer (the contact portion) was formed by charging the edge layer (contact portion) forming liquid onto the surface of the base layer 1 in the centrifugal molding machine maintained at a temperature of 120 °C. As a result, a sheet having a thickness of 1.3 mm was prepared. The sheet had two layers made of polyurethane elastomer. A surface layer has a film thickness of 0.4 mm. After the post-curing, the sheet was processed (including cutting at an obtuse angle) to produce the lubricant leveling blade of Example 1. The Martens hardness, a tan δ peak temperature, and the edge angle were measured by the following methods.

### —Method for Measuring Martens Hardness—

The Martens hardness was measured using a microhardness measurement instrument (FISCHERSCOPE HM2000 available from Fischer Instruments K.K.), under conditions where a Vickers indenter is pressed into the surface of sample with a force of 9.8 mN for 30 seconds, kept for 5 seconds, and drawn up with a force of 9.8 mN for 30 seconds.

### —Method for Measuring Tan δ Peak Temperature—

The tan δ peak temperature was measured using a DMA7100 (manufactured by Hitachi High-Tech Science Corporation) under the conditions of a tensile mode, a temperature rise rate of 2 °C./min, and a frequency of 10 Hz.

### —Method for Measuring Edge Angle—

The edge angle means an angle of the contact portion 602 as illustrated in FIG. 1 and was measured using VHX-8000 (manufactured by KEYENCE Corporation).

### Examples 2 to 5 and Comparative Examples 1 to 2

The lubricant leveling blades of Examples 2 to 5 and Comparative Examples 1 and 2 were produced in the same procedure as in Example 1 under the conditions described in Table 1. The Martens hardness of the edge layer was adjusted by changing the amount of ETHACURE 300 added.

### Comparative Example 3

Instead of ETHACURE 300, 1, 4-butanediol (BD) and trimethylolpropane (TMP) was used to form the edge layer having a Martens hardness of 0.80 N/mm², and the sheet made of polyurethane elastomer was formed by the centrifugal molding method. The other procedures were the same as in Examples 1 to 5.

### Comparative Example 4

The edge layer was made from PLACCEL 220 (manufactured by Daicel (U.S.A.), Inc.) instead of TAKENATE L 2360 and 1, 4-butanediol (BD) and trimethylolpropane (TMP) instead of ETHACURE 300, and the sheet made of polyurethane elastomer was formed by the centrifugal molding method so as to have a Martens hardness of 1.0 N/mm². The other procedures were the same as in Examples 1 to 5.

### Examples 6 to 10 and Comparative Examples 5 and 6

Cleaning blades were produced in the same manner as in Examples 1 to 5, except that the amounts of raw materials injected were changed to adjust the thickness of each of the cleaning blades to 2.0 mm. The Martens hardness and the tan δ peak temperature of the edge layer (the contact portion) of each cleaning blade was measured in the same manner as in Example 1.

### Comparative Example 7

The cleaning blade was produced in the same manner as in Comparative Example 3, except that the amounts of raw materials injected were changed to adjust the thickness of the cleaning blade to 2.0 mm.

### Comparative Example 8

The cleaning blade was produced in the same manner as in Comparative Example 4, except that the amounts of raw materials injected were changed to adjust the thickness of the cleaning blade to 2.0 mm.

The present inventors evaluated the application performance of each of the lubricant leveling blades in Examples 1 to 5 and Comparative Examples 1 to 4 and the cleaning performance of each of the cleaning blades in Examples 6 to 10 and Comparative Examples 5 and 6. The evaluation results are illustrated in Tables 1 to 4 below.

### Evaluation of Application Performance

Each of the lubricant leveling blades that were made in Examples 1 to 5 and Comparative Examples 1 to 4 was mounted on a process cartridge of a color multifunction peripheral (IMAGIO MP C4500 manufactured by Ricoh Co., Ltd.) so as to have a linear pressure of 10 N/m and a cleaning angle of 79°. The process cartridge of IMAGIO MP C4500 includes a printer part that has the same configuration as the image forming unit illustrated in FIG. 4 in the image forming apparatus 500. After the color multifunction peripheral continuously printed images each having an image area rate of 5% on 1,000,000 sheets (A4 size, lateral) in an ordinary temperature environment (that is 23 °C/55% RH) using evaluation toner, the color multifunction peripheral printed a halftone image to evaluate whether a white streak or a black streak occurred on the halftone image. The black streak is an abnormal image that occurs when a lubricant leveling function is degraded due to wear of the tip of the lubricant leveling blade. The white streak is an abnormal image that occurs when the lubricant leveling blade applies the lubricant unevenly in a longitudinal direction of the image bearer. The occurrence of the black streak or the white streak means insufficient function of the lubricant leveling blade. The application performance of the lubricant leveling blade was evaluated by ranks each defined by the following evaluation criteria.
Rank 4: No white or black streaks are seen on the image.
Rank 3: A white streak or a black streak is slightly observed on the image but is within an allowable range.
Rank 2: White streaks or black streaks are slightly observed on the image, and the number of the streaks is large, but the white streaks or black streaks are within the allowable range.
Rank 1: White streaks or black streaks are observed on the image, and the image is not usable.

### Evaluation of Cleaning Performance

Each of the cleaning blades that were made in Examples 6 to 10 and Comparative examples 5 and 6 were mounted on a process cartridge of a color multifunction peripheral (RICOH IM C6000 manufactured by Ricoh Co., Ltd.) so as to have a predetermined tip biting amount (a linear pressure: 20 N/m) and an attachment angle of about 79°. The tip biting amount is defined as a length from an imaginary position of the tip of the cleaning blade when the image bearer does not exist on the surface of the image bearer. Using the evaluation toner, the color multifunction peripheral (RICOH IM C6000) printed a chart (A4 size, lateral) having an image area rate of 0.5% with a vertical band on three sheets in one print job repeatedly until the total printed sheets exceeded 50000 sheets under the ordinary temperature environment (23 °C./55% RH). Then, the occurrence of black streaks on the image was evaluated. The black streak is generated by partial toner slip when fine chipping or local abrasion occurs at the edge of the cleaning blade. The cleaning performance of the cleaning blade was evaluated by ranks each defined by the following evaluation criteria.
Rank 4: No black streak is seen on the image.
Rank 3: A black streak is slightly observed on the image but is within an allowable range.
Rank 2: Black streaks are slightly observed on the image, and the number of the streaks is large, but the black streaks are within the allowable range.
Rank 1: Black streaks are observed on the image, and the image is not usable.

TABLE 1

| | | Example 1 | Example 2 | Example 3 | Example 4 | Example 5 |
|---|---|---|---|---|---|---|
| | | Leveling | Leveling | Leveling | Leveling | Leveling |
| | | blade A | blade B | blade C | blade D | blade E |
| Edge | Polyol | PTMG | PTMG | PTMG | PTMG | PTMG |
| layer | Isocyanate | TDI | TDI | TDI | TDI | TDI |
| | Curing Agent | DMTDA | DMTDA | DMTDA | DMTDA | DMTDA |
| | Martens | 5.0 | 6.5 | 8.4 | 11.7 | 30.0 |
| | Hardness | | | | | |
| | Tan δ peak | 61 °C | 62 °C | 64 °C | 80 °C | 120 °C |
| | temperature | | | | | |
| Base | Material | Urethane | Urethane | Urethane | Urethane | Urethane |
| Layer | | Rubber A | Rubber B | Rubber A | Rubber C | Rubber D |
| | Martens | 0.6 | 0.5 | 0.6 | 1.5 | 1.0 |
| | Hardness | | | | | |
| Edge Angle (°) | | 140 | 125 | 125 | 110 | 110 |
| Results | Rank of black | 3 | 4 | 4 | 4 | 3 |
| | streak due to | | | | | |
| | cleaning | | | | | |
| | failure | | | | | |
| | Rank of white | 2 | 3 | 4 | 4 | 4 |
| | streak due to | | | | | |
| | lubricant | | | | | |
| | application | | | | | |
| | failure | | | | | |

TABLE 2

| | | Example 6 | Example 7 | Example 8 | Example 9 | Example 10 |
|---|---|---|---|---|---|---|
| | | Cleaning | Cleaning | Cleaning | Cleaning | Cleaning |
| | | Blade A | Blade B | Blade C | Blade D | Blade E |
| Edge | Polyol | PTMG | PTMG | PTMG | PTMG | PTMG |
| layer | Isocyanate | TDI | TDI | TDI | TDI | TDI |
| | Curing Agent | DMTDA | DMTDA | DMTDA | DMTDA | DMTDA |
| | Martens | 5.0 | 6.5 | 8.4 | 11.7 | 30.0 |
| | Hardness | | | | | |
| | Tan δ peak | 61 °C | 62 °C | 64 °C | 80 °C | 120 °C |
| | temperature | | | | | |
| Base | Material | Urethane | Urethane | Urethane | Urethane | Urethane |
| Layer | | Rubber B | Rubber B | Rubber B | Rubber A | Rubber A |
| | Martens | 2.0 | 0.5 | 0.5 | 0.6 | 0.6 |
| | Hardness | | | | | |
| Edge Angle (°) | | 90 | 90 | 90 | 90 | 90 |
| Results | Rank of black | 3 | 4 | 4 | 3 | 2 |
| | streak due to | | | | | |
| | cleaning | | | | | |
| | failure | | | | | |

TABLE 3

| | | Comparative | Comparative | Comparative | Comparative |
|---|---|---|---|---|---|
| | | Example 1 | Example 2 | Example 3 | Example 4 |
| | | Leveling | Leveling | Leveling | Leveling |
| | | blade F | blade G | blade H | blade I |
| Edge | Polyol | PTMG | PTMG | PTMG | PCL |
| layer | Isocyanate | TDI | TDI | TDI | TDI |
| | Curing | DMTDA | DMTDA | BD/TMP | BD/TMP |
| | Agent | | | | |
| | Martens | 1.0 | 50.0 | 0.8 | 1.0 |
| | Hardness | | | | |
| | Tan δ peak | −2 °C | 140 °C | −45 °C | −20 °C |
| | temperature | | | | |
| Base | Material | Urethane | Urethane | Urethane | Urethane |
| Layer | | Rubber A | Rubber A | Rubber D | Rubber B |
| | Martens | 0.6 | 0.6 | 1.0 | 0.5 |
| | Hardness | | | | |
| Edge Angle (°) | | 125 | 125 | 110 | 110 |
| Results | Rank of black | 3 | 1 | 3 | 3 |
| | streak due | | | | |
| | to cleaning | | | | |
| | failure | | | | |
| | Rank of white | 1 | 3 | 1 | 1 |
| | streak due | | | | |
| | to lubricant | | | | |
| | application | | | | |
| | failure | | | | |

TABLE 4

| | | Comparative | Comparative | Comparative | Comparative |
|---|---|---|---|---|---|
| | | Example 5 | Example 6 | Example 7 | Example 8 |
| | | Cleaning | Cleaning | Cleaning | Cleaning |
| | | blade F | blade G | blade H | blade I |
| Edge | Polyol | PTMG | PTMG | PTMG | PCL |
| layer | Isocyanate | TDI | TDI | TDI | TDI |
| | Curing | DMTDA | DMTDA | BD/TMP | BD/TMP |
| | Agent | | | | |
| | Martens | 1.0 | 50.0 | 0.8 | 1.0 |
| | Hardness | | | | |
| | Tan δ peak | −2 °C | 140 °C | −45 °C | −20 °C |
| | temperature | | | | |
| Base | Material | Urethane | Urethane | Urethane | Urethane |
| Layer | | Rubber A | Rubber A | Rubber D | Rubber B |
| | Martens | 0.6 | 0.6 | 1.0 | 0.5 |
| | Hardness | | | | |
| Edge Angle (°) | | 90 | 90 | 90 | 90 |
| Results | Rank of black | 1 | 1 | 1 | 1 |
| | streak due | | | | |
| | to cleaning | | | | |
| | failure | | | | |

Aspects of the embodiments of the present disclosure are as follows, for example.

### First Aspect

In a first aspect, a blade for electrophotography includes an elastic body including a contact portion contacting a surface of an image bearer. The contact portion is made of a polyurethane elastomer containing a reaction product of polytetramethylene ether glycol, aromatic isocyanate, and amine and has a Martens hardness of 5.0 N/mm² or more and 30.0 N/mm² or less.

### Second Aspect

In a second aspect, the polyurethane elastomer of the blade for electrophotography according to the first aspect has a tan δ peak temperature equal to or higher than 60 °C.

### Third Aspect

In a third aspect, the elastic body of the blade for electrophotography according to the first aspect or the second aspect has a laminated structure including two or more layers that include an edge layer and a base layer.

### Fourth Aspect

In a fourth aspect, the elastic body of the blade for electrophotography according to any one of the first to third aspects has a tip edge line portion having an angle from 900 to 140°.

### Fifth Aspect

In a fifth aspect, the elastic body of the blade for electrophotography according to any one of the first to fourth aspects includes a base layer made of polyurethane elastomer and having a Martens hardness from 0.5 N/mm² to 2.0 N/mm² and an edge layer on the base layer. The edge layer is on the base layer and has the contact portion.

### Sixth Aspect

In a sixth aspect, an image forming apparatus includes an image bearer, a charger to charge a surface of the image bearer, an irradiator to irradiate the surface of the image bearer charged by the charger with light to form an electrostatic latent image, a developing device to develop the electrostatic latent image and form a toner image on the surface of the image bearer, a transferor to transfer the toner image on the surface of the image bearer onto a recording medium, a fixing device to fix the toner image on the recording medium, and the blade for electrophotography according to any one of the first to fifth aspects to remove toner remaining on the image bearer.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

This patent application is based on and claims priority to Japanese Patent Application No. 2023-119650, filed on Jul. 24, 2023, in the Japan Patent Office, the entire disclosure of which is hereby incorporated by reference herein.

### REFERENCE SIGNS LIST

601: Blade for electrophotography
6011: Edge layer
6012: Base layer
6013: Support
602: Contact portion
3: Image bearer
1 1Y 1C 1M 1K: Imaging forming units
2: Frame body
3 3Y 3C 3M 3K: Photoconductors
4: Charging roller
5 5Y 5C 5M 5K: Developing devices
6: Cleaning device
7 7Y 7C 7M 7K: Primary transfer rollers
10: Lubricant leveling device
14: Intermediate transfer belt
40: Optical writing unit
41: Polygon mirror
51: Developing roller
52: Supply screw
53: Stirring screw
54: Doctor
55: Registration roller pair
60: Transfer unit
62: Cleaning blade
63: First bracket
64: Second bracket
66: Secondary transfer backup roller
67: Driving roller
68: Auxiliary roller
69: Tension roller
70: Secondary transfer roller
80: Fixing unit
81: Pressure heating roller
82: Fixing belt unit
83: Heating roller
84: Fixing belt
85: Tension roller
86: Driving roller
87: Ejection roller pair
88: Stack part
100Y, 100C, 100M, 100K: Toner cartridges
101: Fur brush
103: Solid lubricant
103a: Lubricant pressing spring
103b: Bracket
104: Lubricant leveling blade
151: First sheet feed tray
151a: First sheet feeding roller
152: Second sheet feed tray
152b: Second sheet feeding roller
153: Sheet feeding path
154: Conveyance roller pair
162: Belt cleaning unit
162a: Belt cleaning blade
500: Image forming apparatus
L: laser light
P: Recording medium

1. A blade for electrophotography, comprising:
an elastic body including a contact portion to contact a surface of an image bearer,
wherein:
the contact portion includes a polyurethane elastomer containing a reaction product of polytetramethylene ether glycol, aromatic isocyanate, and amine, and
the contact portion has a Martens hardness of 5.0 N/mm² or more and 30.0 N/mm² or less.

2. The blade for electrophotography according to claim 1, wherein:
the polyurethane elastomer has a tan δ peak temperature equal to or higher than 60 °C.

3. The blade for electrophotography according to claim 1, wherein:
the elastic body includes a laminated structure including two or more layers that include an edge layer and a base layer.

4. The blade for electrophotography according to claim 1, wherein:
the elastic body includes a tip edge line portion having an angle from 90° to 140°.

5. The blade for electrophotography according to claim 1, wherein the elastic body includes:
a base layer including polyurethane elastomer and having a Martens hardness from 0.5 N/mm² to 2.0 N/mm²; and
an edge layer on the base layer, the edge layer including the contact portion.

6. An image forming apparatus, comprising:
an image bearer;
a charger to charge a surface of the image bearer;
an irradiator to irradiate the surface of the image bearer charged by the charger with light to form an electrostatic latent image;
a developer to develop the electrostatic latent image and form a toner image on the surface of the image bearer;
a transferor to transfer the toner image on the surface of the image bearer onto a recording medium;
a fixer to fix the toner image on the recording medium; and
the blade for electrophotography according to claim 1 to remove toner remaining on the image bearer.
